(19) United States
(12) Patent Application Publication
(10) Pub. No.: US 2026/0362241 A1
(43) Pub. Date: Nov. 12, 2026

(54) METHODS FOR FAST AND POWER EFFICIENT BANDWIDTH ADAPTATION

(71) Applicant: InterDigital Patent Holdings, Inc., Wilmington, DE (US)

(72) Inventors: Martino Freda, Laval (CA); Brian Martin, Farnham (GB); Keiichi Kubota, Setagaya-Ku (JP); Samuli Turtinen, Ii (FI); Faris Alfarhan, Montreal (CA); Tuong Hoang, Montreal (CA); Ghyslain Pelletier, Montreal (CA); Benoit Pelletier, Roxboro (CA)

(73) Assignee: InterDigital Patent Holdings, Inc., Wilmington, DE (US)

(21) Appl. No.: 19/202,726

(22) Filed: May 8, 2025

(51) Int. Cl. H04W 28/20; H04B 17/318; H04W 28/08; H04W 72/1263

(52) U.S. Cl. CPC H04W 28/20; H04B 17/328; H04W 28/0983; H04W 72/1263

(57) ABSTRACT

Systems, methods, and apparatuses for fast and power-efficient bandwidth adaptation are disclosed herein. A wireless transmit/receive unit (WTRU) may receive a threshold value and a mapping of one or more codepoints to respective frequency resource configurations. The WTRU may receive low-power (LP) signal(s). The WTRU may detect a codepoint of the one or more codepoints based on the LP signals. For example, the WTRU may determine one or more transmission characteristics of the LP signals to detect the codepoint. The WTRU may determine a frequency resource configuration associated with the detected codepoint based on the detected codepoint and the mapping. The WTRU may measure one or more frequency resources based on the determined frequency resource configuration, and may transmit indications of measurements associated with a subset of the one or more frequency resources.

### BACKGROUND

Fifth generation (5G) techniques for bandwidth (BW) adaptation (e.g., bandwidth part (BWP), dormancy, etc.) may be tailored for CONNECTED mode wireless transmit/receive units (WTRUs). Specifically, the WTRU may need to maintain a minimal level of physical downlink control channel (PDCCH) monitoring and channel state information (CSI) reporting to be able to receive a bandwidth adaptation command from the network. This may not be acceptable when trying to design a system which is “always on” from the radio resource control (RRC) perspective (e.g., based on the sixth generation (6G) assumptions described herein), as it may result in much longer periods of “inactivity” where the WTRU is actually performing heavy processing (e.g., CSI measurements, PDCCH monitoring) albeit on a smaller bandwidth.

A WTRU bandwidth adaptation technique that maximizes power savings during the “inactive” period but enables fast system re-entry to an active period where the WTRU can be scheduled efficiently based on the requirements at that time may be needed.

### SUMMARY

Systems, methods, and apparatuses for fast and power-efficient bandwidth adaptation are disclosed herein. One or more of the methods disclosed herein may be implemented by a wireless transmit/receive unit (WTRU) and/or a user equipment (UE), for example via a processor thereof. One or more low-power (LP) signal(s) may encode N codepoints. N codepoints signaled by LP signal(s) may be configured (e.g., via RRC) with a representation. LP signal(s) may control monitoring of (an) other LP signal(s). An LP signal codepoint configuration may apply for a finite time. An LP signal configuration may be conditioned on (e.g., other) factors at the WTRU. Resource behavior (e.g., following LP signal reception) may be a function of WTRU triggers. Resource behavior may be determined by measurements (e.g., CSI). Resource behavior (e.g., following LP signal reception) may follow a predefined/configured pattern of time and/or frequency. Resource behavior may change as a result of data arrival triggers.

A WTRU may receive a threshold value and a mapping of one or more codepoints to respective frequency resource configurations (e.g., via radio resource control (RRC) message). The WTRU may receive low-power (LP) signal(s). The WTRU may detect a codepoint of the one or more codepoints based on the LP signals. For example, the WTRU may determine one or more transmission characteristics of the LP signals to detect the codepoint. The one or more transmission characteristics of the one or more low-power signals may include a transmission time associated with the one or more low-power signals, a reception time associated with the one or more low-power signals, a transmission duration associated with the one or more low-power signals, a transmission frequency associated with the one or more low-power signals, and/or an encoding method associated with the one or more low-power signals. The WTRU may determine a frequency resource configuration associated with the detected codepoint based on the detected codepoint and the mapping. A frequency resource configuration may include one or more of a respective configured resource configuration, a respective set of configured carriers or resource blocks (RBs), a respective configured center frequency, bandwidth, and numerology, or a respective CSI measurement configuration. The CSI measurement configuration may include one or more of an indication of one or more reference signals, a minimum or maximum CSI reporting time, a minimum or maximum time between reception of a low-power signal of the one or more low-power signals and physical downlink control channel monitoring, an association between a low-power signal occasion and a main radio (MR) associated with the WTRU, or a WTRU monitoring procedure.

The WTRU may monitor for the one or more low-power signals in a configured set of monitoring occasions. For example, the WTRU may activate physical downlink control channel (PDCCH) monitoring in the one or more frequency resources within a configured PDCCH monitoring latency. The WTRU may measure one or more frequency resources based on the determined frequency resource configuration, and may transmit indications of measurements associated with a subset of the one or more frequency resources. For example, the WTRU may measure a first frequency resource, determine that the first frequency resource is associated with a channel state information (CSI) reference signal received power (RSRP) value that is greater than the received threshold value, and may transmit, to the network, an indication of a measurement associated with the first frequency resource. Alternatively, the WTRU may determine that the first frequency resource (e.g., or a second frequency resource) is associated with a CSI RSRP value that is less than or equal to the received threshold value, and may determine not to transmit an indication of a measurement associated with the first frequency resource.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a simplified receiver architecture of a WTRU utilizing a low-power wake-up receiver.

FIG. 3 is an example flowchart of a procedure for fast and power-efficient bandwidth adaptation.

### DETAILED DESCRIPTION

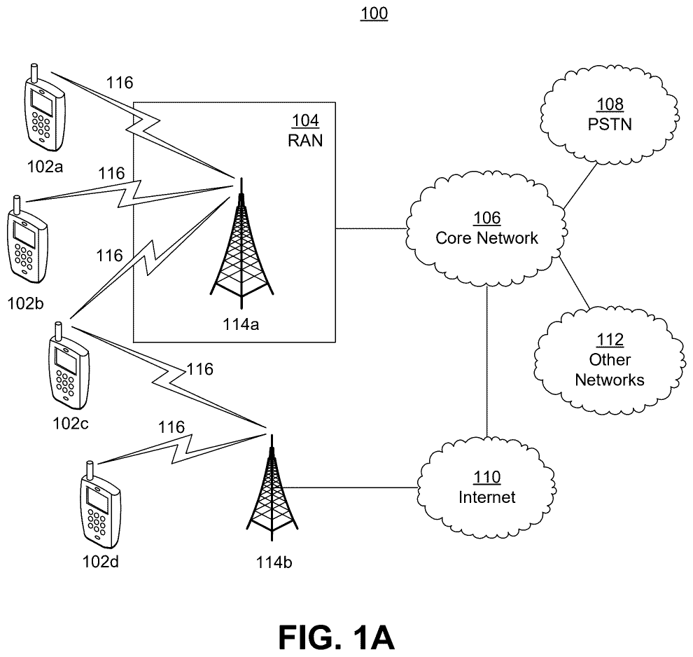

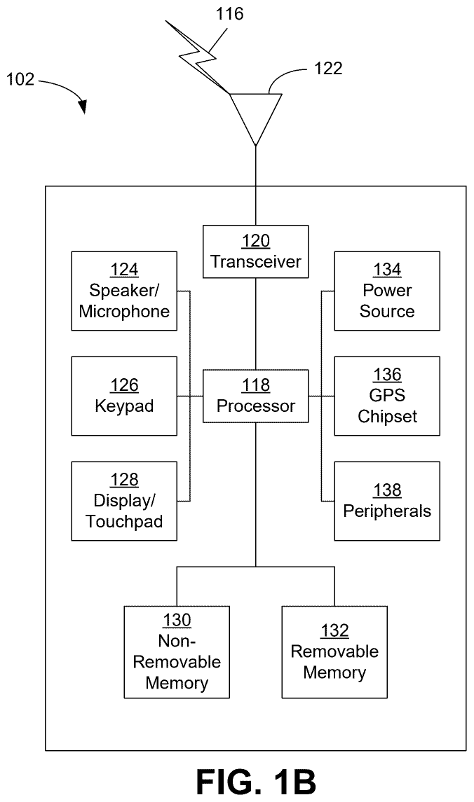

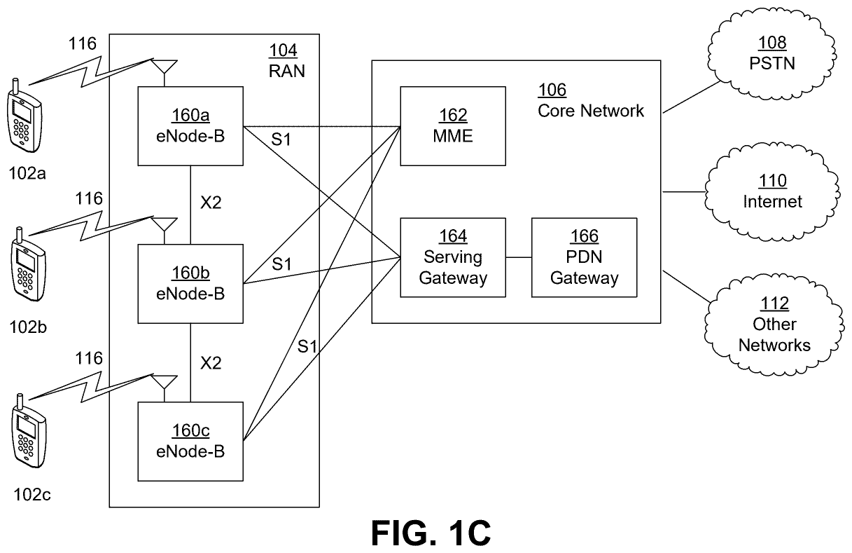

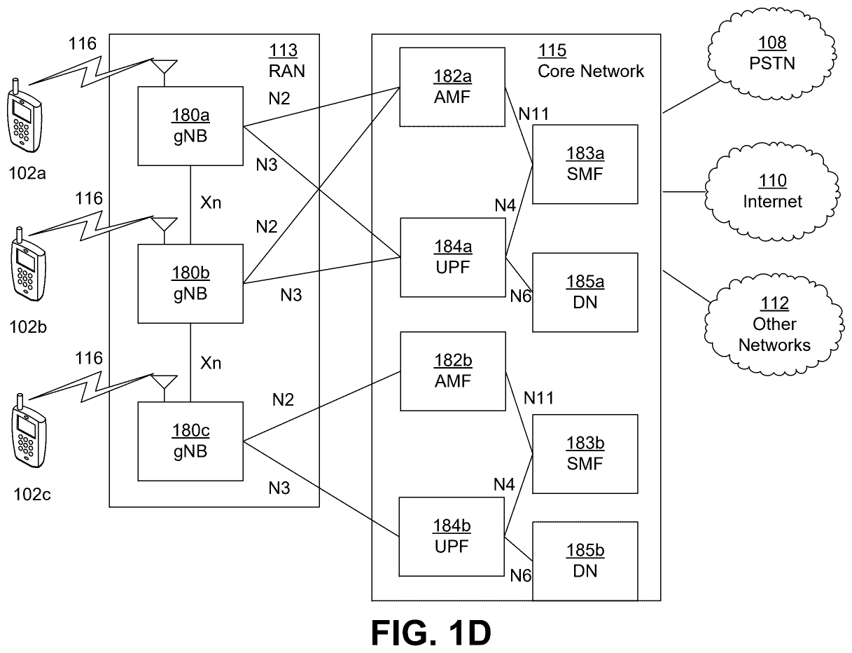

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reconfiguration in new radio (NR) may be performed. Mobility in NR may be based on radio resource control (RRC) reconfiguration. In RRC reconfiguration, a wireless transmit/receive unit (WTRU) may receive an RRC message with a full configuration of one or more (e.g., all) possible RRC parameters, or a delta configuration which changes (e.g., only certain) RRC parameters to be changed, leaving the parameters not included to be unchanged compared to the currently stored/applied configuration.

Mobility in NR may be disclosed herein. In handover, a WTRU may receive an RRC configuration of the target cell in the handover command. The RRC configuration may be a full configuration or delta configuration, and may represent the WTRU's configuration to use in the target cell.

To reduce the latency associated with layer 3 (L3) mobility, NR also introduces layer 1/layer 2 (L1/L2) mobility (LTM). In LTM, the WTRU may receive a list of candidate cell configurations in advance (e.g., before the handover). The cell switch command may be issued with a cell identifier (ID), and the WTRU may use the cell configuration it has stored for the respective cell.

NR bandwidth adaptation may be performed. A number of techniques exist in 5G to adapt WTRU resource usage to tradeoff power consumption versus bandwidth requirements by adapting the frequency bandwidth. Bandwidth adaptation in NR has evolved over multiple releases since release 15 (R15). Following the introduction of the carrier aggregation (CA) concept, enhancements to CA as well as more efficient mechanisms to adapt the operating bandwidth, while ensuring a faster adaptation of the bandwidth, were introduced. The result was a number of different mechanisms and features (e.g., CA, bandwidth part (BWP), dormancy) each addressing the aspect of BW adaptation but in a different way, and each having characteristics as shown in Table 1 below:

TABLE 1

| | WTRU or | | | |
|---|---|---|---|---|
| | cell | Resource | Signaling for | |
| Technique | specific | Applicability | adaptation | Purpose |
| CA | Cell | Applicable | RRC on the | Provide WTRU with |
| | specific | only to a SCell | primary carrier | additional bandwidth |
| | | resources | | using another cell |
| | | | | (besides the PCell). |
| Cell | Cell | Applicable | MAC CE | Be able to |
| Activation/ | specific | only to a SCell | (On/Off) on the | add/remove carriers |
| Deactivation | | resources | primary carrier | more quickly using |
| | | | and relying on | MAC signaling |
| | | | RRC | instead of RRC. |
| | | | preconfiguration | |
| BWP | WTRU | All resources | DCI (by selecting | Be able to change to |
| | specific | | an RRC | different WTRU |
| | | | configured BW | specific bandwidths |
| | | | configuration) | and numerology |
| Dormancy | WTRU | Applicable | DCI | Be able to |
| | specific | only to a SCell | | add/remove additional |
| | | resources | | BW (CA) more quickly |
| | | | | compared to cell |
| | | | | activation/deactivation |
| | | | | because the WTRU |
| | | | | continues to perform |
| | | | | CSI measurements |
| | | | | on de-activated SCell. |

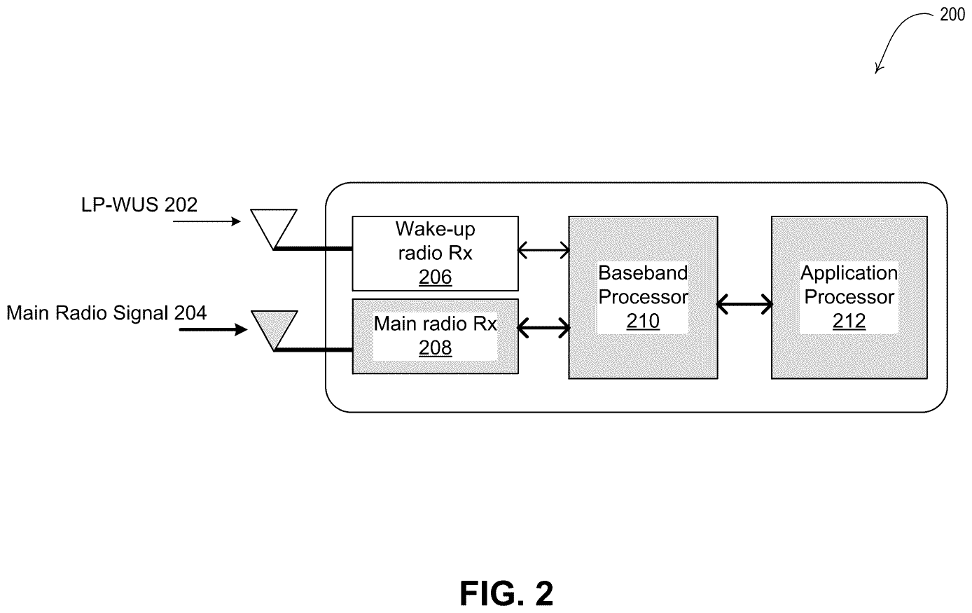

NR wakeup signal(s) may be disclosed herein. FIG. 2 illustrates a simplified receiver architecture 200 of a WTRU utilizing a low-power wake-up receiver 206. A low power (LP) wakeup signal (WUS) 202 was introduced in NR for time domain power savings. With LP-WUS 202, the WTRU may monitor and receive a wake-up signal (WUS) 202 via a first radio (e.g., a low-power or ultra-low power radio). Receiving the WUS 202 may trigger wake-up or use of a second radio of the WTRU (e.g., the WTRU's main radio (MR) for data and/or control signal transmission and/or reception. The low power radio (LR) and MR may not be implemented by the same radio. As shown in FIG. 2, the receiver architecture 200 may include a main radio receiver 208 that may receive a main radio signal 204, a baseband processor 210, and/or an application processor 212.

LP-WUS may be used in NR in conjunction with discontinuous reception (DRX). As with downlink control information (DCI) with cyclic redundancy check (CRC) scrambled by power saving radio network temporary identifier (PS-RNTI) (DCP), the WTRU may monitor LP-WUS monitoring occasions (MO(s)) a configured time before the on-duration occasion to determine if LP-WUS is indicated. If the WTRU detects the WUS, it may monitor the drx-onDuration Timer as normal. Otherwise, it may continue to sleep.

An important consideration in sixth generation (6G) may be power savings at the WTRU. Techniques that achieve efficient power savings may need to be designed from the first release of 6G. Furthermore, in order to avoid design of several distinct features, the power savings technique may be applicable (e.g., equivalently) to WTRUs with different capabilities (e.g., the same mechanism should be applicable both for internet of things (IOT)-like WTRUs, as well as higher capability and bandwidth devices), and regardless of the services active at the WTRU.

Power savings techniques may rely heavily on adapting the operating frequency of the WTRU at a given time. Especially for WTRUs which are designed in a modular fashion, frequency adaptation may lead to significant power savings since the power consumption at the WTRU is heavily dependent on the number of resource blocks the WTRU must be active on. This may include measuring and reporting layer 1 (L1) signals (e.g., CSI measurements), signals for mobility, transmission of sounding reference signal (SRS), etc.

Another important assumption for 6G may be the need to handle bursty traffic with potentially long periods of inactivity. In previous generations, power savings in the presence of bursty traffic may have been achieved by frequent transitions between RRC states, where a (e.g., each) RRC state was inherently associated with a level of activity or reachability at the WTRU. RRC state transition may contribute a significant amount of overhead in signaling and latency at the WTRU, and possible 6G improvements may consist of moving away from multiple RRC states (e.g., or implication of the RRC layer when transitioning between different activity levels at the WTRU). Instead, for example, the WTRU may be (e.g., always) RRC connected, and different levels of activity at the WTRU can be handled by the medium access control (MAC) layer (e.g., the distributed unit (DU)) without RRC involvement.

In order to achieve the same or better energy savings at the WTRU as an IDLE/INACTIVE state, the periods of inactivity may require a strict minimum of power consumption at the WTRU. An approach focused on reduction of the monitoring time (e.g., IDLE/CONNECTED DRX) may achieve this, but may not be able to handle bursty traffic due to the latency associated with re-enabling the active state (e.g., DRX cycle).

Another assumption for 6G may be the management of disjoint physical resource blocks (PRBs) by a WTRU. For example, PRBs allocated to a WTRU may be typically contiguous in frequency to avoid complex filtering or the use of multiple reception (RX) chains. Although some WTRUs may not support this, the network may still configure such support to certain WTRUs depending on the data or service active at the WTRU which supports higher capabilities. There may therefore be a need to manage the characteristics of the operational bandwidth in a more dynamic and per-WTRU fashion for 6G.

5G techniques for BW adaptation (e.g., BWP, dormancy, etc.) may be tailored for CONNECTED mode wireless transmit/receive units (WTRUs). Specifically, the WTRU may need to maintain a minimal level of PDCCH monitoring and CSI reporting to be able to receive a bandwidth adaptation command from the network. This may not be acceptable when trying to design a system which is “always on” from the RRC perspective (e.g., based on the 6G assumptions described herein), as it may result in much longer periods of “inactivity” where the WTRU is actually performing heavy processing (e.g., CSI measurements, PDCCH monitoring) albeit on a smaller bandwidth.

A WTRU bandwidth adaptation technique that maximizes power savings during the “inactive” period but enables fast system re-entry to an active period where the WTRU can be scheduled efficiently based on the requirements at that time may be needed.

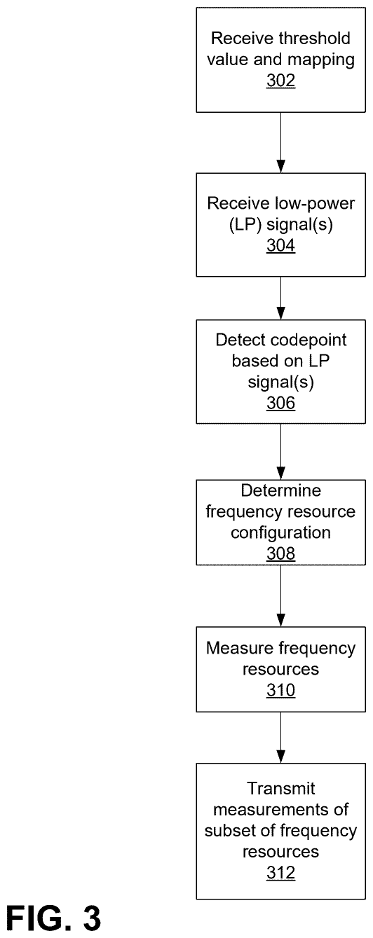

FIG. 3 is an example flowchart of a procedure for fast and power-efficient bandwidth adaptation. A WTRU may determine an operating bandwidth and a function to operate (e.g., PDCCH monitoring, CSI reporting, radio link monitoring (RLM), mobility measurements, etc.) and/or their configuration(s) based on reception of one or more low-power signals and/or WTRU measurements (e.g., CSI measurements).

As shown in FIG. 3, at 302, the WTRU may be configured (e.g., via RRC) with a threshold value (e.g., a threshold CSI reference signal received power (RSRP)), and/or a mapping of codepoints indicated by one or more low-power signals (e.g., based on the time, frequency, modulation type, etc. of the received low-power signal(s) to one or more frequency resource configurations. For example, the WTRU may determine one or more transmission characteristics (e.g., a frequency of the one or more low-power signals, a time of the one or more low-power signals, or a modulation type of the one or more low-power signals, etc.) of the one or more low-power signal(s), and may detect a codepoint (e.g., which may equivalently be referred to as a “code point” herein) based on the determined transmission characteristic(s). The one or more transmission characteristics of the one or more low-power signals may include, for example, a transmission time associated with the one or more low-power signals, a reception time associated with the one or more low-power signals, a transmission duration associated with the one or more low-power signals, a transmission frequency associated with the one or more low-power signals, and/or an encoding method associated with the one or more low-power signals.

The frequency resource configurations may include a configured resource configuration (e.g., a pool of time/frequency resources); one or more configured carriers and/or sets of RBs; a configured center frequency, bandwidth, and/or numerology; and/or a CSI measurement configuration, which may include an RS configuration for a (e.g., each) bandwidth part). For example, the RS configuration may include one or more RS signals to monitor, a minimum/maximum CSI reporting time (e.g., time between reception of the one or more low-power signal(s) and the CSI report); a minimum/maximum time between reception of the low-power signal(s) and physical downlink control channel (PDCCH) monitoring; an association between a low-power signal occasion/configuration and 5G main radio (MR) or 6G MR (e.g., if the cell supports multi-RAT resource sharing (MRSS); and/or a WTRU monitoring procedure to perform, for example, RLM, BFD, etc., to perform after reception of the low-power signal(s).

At 304, the WTRU may monitor for (e.g., receive) one or more low power signal(s), for example in a configured set of monitoring occasions. At 306, the WTRU may detect a codepoint(s) based on the received LP signal(s).

Upon detection of one or more configured codepoints of the low power signal(s), the WTRU may: determine the frequency configuration for the main radio based on the detected codepoint(s) and the RRC configuration information at 308; activate CSI measurements in the configured frequency resource(s) at 310; determine a subset of the frequency resources with CSI RSRP above (e.g., greater than) the received threshold; report the CSI to the network (e.g., for the determined subset) within the configured CSI reporting latency at 312; and/or activate PDCCH monitoring in the determined frequency resources within the configured PDCCH monitoring latency. For example, the WTRU may measure a first frequency resource, determine that the first frequency resource is associated with a channel state information (CSI) reference signal received power (RSRP) value that is greater than the received threshold value, and may transmit, to the network, an indication of a measurement associated with the first frequency resource. Alternatively, the WTRU may determine that the first frequency resource (e.g., or a second frequency resource) is associated with a CSI RSRP value that is less than or equal to the received threshold value, and may determine not to transmit an indication of a measurement associated with the first frequency resource.

Herein, a set of resources at the WTRU may consist of any of the following: a bandwidth or bandwidth part, which may consist of a set of contiguous time resources defined over a fixed bandwidth characterized by any of a combination of a center frequency, a bandwidth (e.g., in Hz), a number of resource blocks, a maximum/minimum frequency for the edge resource blocks, a numerology, etc.; the set of resources, possibly in a bandwidth or bandwidth part, which occupies a continuous and finite period of time (e.g., a number of ms), a number of slots, a number of frames, etc.; and/or a pattern of time/frequency resources which may be fixed in frequency (e.g., the same specific resource blocks occurring on a set of varying time instances), fixed in time (e.g., periodically occurring time resources which can occur on a set of varying resource blocks), or variable in time and frequency. A pattern may be defined for a finite period of time, or may repeat itself a number of times or indefinitely.

Resource-related actions may be disclosed herein. A WTRU may be configured with a number of resource-related actions. Such actions may be controlled by network signaling, as described herein. Alternatively, such actions may be configured by events at the WTRU.

Resource-related actions or control may fall under the categories of control of one or more of the following: control of the reception resources (e.g., time, frequency, bandwidth, pattern) for control (PDCCH), data (physical downlink shared channel (PDSCH)), or low-power signaling (e.g., LP-WUS); control of transmission resources (e.g., time, frequency, bandwidth, pattern) for control (physical uplink control channel (PUCCH)), data (physical uplink shared channel (PUSCH)), or low-power signaling (e.g., LP-WUS); control of CSI measurements (e.g., the measurement resources, RS configuration, measurement filtering, etc.); control of mobility/RRM measurements (e.g., the measurement resources, RS configuration, measurement filtering, etc.); reporting of measurements (e.g., CSI, RRM, etc.) (e.g., conditions for reporting, resources for reporting, etc.); control and triggering of RLM/radio link failure (RLF); performing beam measurements; control and triggering of beam failure detection (BFD); control of SRS transmission; and/or control of resource split between resources for different functions in a set of resources (e.g., split between resources for control and data, split between resources for uplink (UL) and downlink (DL), and/or split between resources for one RAT (e.g. 5G resources) and another (e.g., 6G resources), for example, in the case of Multi-Rat Resource Sharing (MRSS)).

For a (e.g., each) category described herein, a control action may consist of anything related to one or more of the following: enabling/disabling of an activity related to the category; changing the resources related to an activity; defining the time instant and/or resource(s) when an operation will start, stop, etc.; and/or defining the amount of time in which an operation is performed.

A control action may include enabling/disabling of an activity related to the category. For example, this may consist of activating or deactivating the monitoring or reception on a set of resources, such as activating or deactivating RS measurements, PDCCH monitoring, CSI measurements, measurement reporting, SRS transmissions, etc. This may consist of enabling/disabling of the operation itself, enabling/disabling the operation on a set of resources, or enabling/disabling the operation on specific resources. Alternatively, a specific type of monitoring on a set of resources may be enabled or disabled. For example, PDCCH monitoring may be performed using multiple search spaces or coresets, where a specific search space or coreset monitoring may be enabled/disabled.

A control action may include changing the resources related to an activity. For example, this may consist of: changing the bandwidth, time, periodicity, pattern, etc. of resources associated with any of the categories described herein; increasing or decreasing the resources by a defined amount, a defined set of resources, a defined pattern, or a defined rule; and/or determining the number of resources for the specific activity (e.g., number of RB, number of slots, etc.), possibly defined with a time and/or frequency window.

A control action may include defining the time instant and/or resource(s) when an operation will start, stop, etc. For example, this may include defining the absolute time when CSI measurements are started/reported, defining the relative time when CSI measurements are started/reported; and/or defining the maximum or minimum time requirements for the start/stop of an activity (e.g., CSI measurements) by a WTRU.

A control action may include defining the amount of time in which an operation is performed. For example, this may include defining or configuring a timer related to PDCCH monitoring, CSI reporting, etc., and/or defining or configuring a timer related to testing a condition which may trigger (e.g., enable, disable, perform) an operation.

WTRU radio configurations may be disclosed herein. A WTRU may be configured with one or more main radios (MR) which allow the WTRU to transmit and receive one or more (e.g., all) of the categories described herein, on one or more (e.g., all or a subset of) resources. The WTRU MR may be assumed to be the radio enabling transmission and reception of data by the WTRU.

A specific MR may operate on a set of fixed resources, a set of configurable resources, or on a set of WTRU defined resources. For example, a (e.g., one) MR may provide access to a frequency contiguous set of resources such as a carrier frequency or bandwidth part (BWP), and operating multiple MRs at a WTRU may allow the WTRU to operate in multi-carrier, or have multiple active BWPs simultaneously.

Alternatively, multiple MRs may be operated on the same set of resources to enable the WTRU to perform simultaneous or discontinuous operations on a set of resources, such as multiple discontinuous resource block transmission in the same slot, simultaneous performance of measurements and transmission in the same resource set, etc.

In addition to one or more MR(s), the WTRU may be configured with one or more low power radios (LR). A low-power radio may allow the WTRU to perform detection on network signaling with lower power consumption. The low-power radio may have limited/no data decoding capabilities and may be limited to simple energy detection, detection of a small number of codewords in a number of resources, etc. A (e.g., each) LR may be used to initiate or trigger resource related operations on the MR.

A (e.g., each) LR may be associated with a corresponding MR. Specifically, a (e.g., each) LR may trigger a resource operation for the resources configured to be associated with the resources the MR transmits/receives on.

Multiple LRs may be associated with one or more MRs. Specifically, one or more LRs (e.g., each of the LRs) may independently or together configure or control the resource operations of one MR, or of multiple MRs. For example, a (e.g., each) LR may control different functions on the resources controlled by the MR(s) (e.g., LR #1 controlling CSI measurements and LR #2 controlling PDCCH monitoring BW). Multiple LRs may control the same functions or resources to ensure reliability. For example, a first LR may control the operation of decoding the second LR.

One or more network-signaled resource control methods may be disclosed herein. A low-power (LP) signal may encode one or more (e.g., N) codepoints.

In one or more of the embodiments described herein, a WTRU may determine one of a number of codepoints from the reception of one or more LP signal(s). A (e.g., each) codepoint may signal a resource configuration aspect, or resource activity behavior at the WTRU. The WTRU may be configured with the association between a (e.g., each) codepoint and the corresponding resource configuration aspect or resource activity behavior. Alternatively, the association may be specified.

A codepoint may be indicated by one or more of: LP signal encoding, LP signal transmission time, LP signal transmission duration by the network, LP signal transmission frequency/carrier/BWP/RB, LP signal transmission bandwidth (BW), and/or LP signal reception energy.

A codepoint may be indicated by LP signal encoding. For example, LP signal may be transmitted with a specific modulation scheme (e.g., OOK, QPSK, OFDM, etc).

A codepoint may be indicated by LP signal transmission time. For example, reception of an LP signal at the WTRU at different time instances may indicate a different codepoint. For example, this may consist of a different frame or slot number or absolute timing reference. Reception of an LP signal in frame/slot X may indicate a first codepoint, while reception of LP signal in frame/slot Y may indicate a second codepoint.

Reception of an LP signal at the WTRU at a different time instant relative to another transmission/reception may indicate a different codepoint. For example, this may consist of: the time between a WTRU transmission, possibly on the MR, and reception on the LP radio; the time difference between a WTRU reception, possibly on the MR, and reception on the LP radio; the time difference between the time the WTRU turns on/off the MR and the reception of the LP signal; the specific transmission or reception (e.g., DCI type reception, CSI report transmission (and the type of CSI report), SRS transmission, etc) performed by the WTRU, and the reception of an LR signal after that specific transmission or reception may further indicate different codepoints; and/or the contents of a transmission or reception by the WTRU, possibly performed with the MR.

For the time between a WTRU transmission, possibly on the MR, and reception on the LP radio, if an LP signal is received after a first time difference X following transmission by the WTRU (e.g., SRS), the WTRU may detect a first codepoint. If an LP signal is received after a second time difference Y following transmission by the WTRU (e.g., SRS), the WTRU may detect a second codepoint.

For the time difference between a WTRU reception, possibly on the MR, and reception on the LP radio, if an LP signal is received after a first time difference X following reception by the WTRU (e.g., of a DCI), the WTRU may detect a first codepoint. If an LP signal is received after a second time difference Y following reception by the WTRU (e.g., of a DCI), the WTRU may detect a second codepoint.

For the time difference between the time the WTRU turns on/off the MR and the reception of the LP signal, if an LP signal is received after a first time difference X following the time the WTRU turns off the MR, the WTRU may detect a first codepoint. If an LP signal is received after a second time difference following the time the WTRU turns off the MR, the WTRU may detect a second codepoint.

For the specific transmission or reception (e.g., DCI type reception, CSI report transmission (and the type of CSI report), SRS transmission, etc.) performed by the WTRU, and the reception of an LR signal after that specific transmission or reception may further indicate different codepoints, if an LP signal is received after a CSI report, it may indicate a first codepoint. If the LP signal is received after an SRS transmission, it may indicate a second codepoint.

For the contents of a transmission or reception by the WTRU, possibly performed with the MR, if the contents of a WTRU's transmission (e.g., MAC CE) contain a first set of information, reception of an LP signal may indicate a first codepoint. If the contents of a WTRU's transmission contain a second set of information, reception of an LP signal may indicate a second codepoint.

A codepoint may be indicated by LP signal transmission duration by the network. For example, the duration of LP signal may indicate different codepoints. For example, if a WTRU detects LP signal transmission over a first duration, it may indicate a first codepoint, and if the WTRU detects LP signal transmission over a second duration it may indicate a second transmission.

A codepoint may be indicated by LP signal transmission frequency/carrier/BWP/RB. For example, a codepoint can be derived from the frequency, carrier, BWP, or RB in which the WTRU receives an LP signal. Specifically, if the WTRU receives LP signal(s) in a first frequency, it may indicate a first codepoint, while if the WTRU receives LP signal(s) in a second frequency, it may indicate a second codepoint.

A codepoint may be indicated by LP signal transmission bandwidth (BW). For example, a codepoint may be derived by the detected bandwidth of the LP signal(s) at the WTRU. For example, if the LP signal(s) are detected over a first bandwidth, it may indicate a first codepoint, while if the LP signal(s) are detected over a second codepoint it may indicate a second codepoint.

A codepoint may be indicated by LP signal reception energy. For example, a codepoint may be derived by the LP signal reception energy or power at the WTRU or the range of such. For example, if the LP signal reception energy or power falls in a first configured range, it may indicate a first codepoint, while if the LP signal reception energy or power falls in a second configured range, it may indicate a second codepoint.

The WTRU may use a combination of different factors to determine the specific codepoints which are associated with the resource-related actions. Specifically, one or more (e.g., all) combinations of a first and a second factor may signal a set of codepoints. Alternatively, a first factor may signal a first subset of actions, while a second factor may signal the specific action within the first subset of actions.

The WTRU may use a combination of multiple LP signals to determine the specific codepoints which are associated with the resource-related actions. Specifically, if a WTRU supports multiple LP radios, reception from the different LP radios may in combination indicate a larger number of codepoints.

N codepoints signaled by an LP signal(s) may be configured (e.g., with RRC) with a representation.

The WTRU may be configured (e.g., by RRC, MAC CE, etc.) with a representation or significance for each codepoint signaled by the one or more LP signal(s). For example, one or more of the following may apply: a codepoint may refer to a configuration previously provided to the WTRU; a codepoint may refer to one or a group of WTRUs; a codepoint may indicate an action to be performed, or may be used for a trigger, possibly associated with the MR or another LR; a codepoint may indicate a function at the WTRU, for which an action is to be performed, which is to be configured, etc.; a codepoint may indicate a resource or a set of resources; a codepoint may indicate a decoding rule or format for a subsequent network signal, message, protocol, etc.; and/or a codepoint may indicate a configuration element that a subsequent configuration message may refer to.

A codepoint may refer to a configuration previously provided to the WTRU. For example, a WTRU may receive multiple configurations (e.g., by RRC, MAC CE, etc.) configuring a resource-related action or activity. For example, a (e.g., each) configuration may indicate one or more of: a monitoring bandwidth for the WTRU; a PDCCH search space configuration; a CSI measurement configuration; a CSI reporting configuration; and/or an RLM/RLF configuration (e.g., including whether to perform RLM/RLF at a given time, the resources to measure and/or a configuration of timers/constants to control RLF triggering), etc.

A (e.g., each) codepoint may reference one of the one or more (e.g., multiple) configurations received/stored by the WTRU. Upon reception of the LP signal, the WTRU may apply the configuration associated with the received codepoint. The WTRU may apply the configuration immediately. Alternatively, the WTRU may apply the configuration at a future time, indicated by another LP signal, by another aspect or trigger (e.g., timer, DRX, paging), etc.

A codepoint may refer to one or a group of WTRUs. For example, a WTRU may be configured with one or more codepoint(s) which refers to that specific WTRU. Specifically, a codepoint may be mapped to one or more WTRUs or a group of WTRUs. A WTRU may determine the codepoint associated with it based on one or more of: configuration (e.g., RRC); mapping to a WTRU ID; mapping to a WTRU type or capability; and/or mapping to a configured identifier.

A codepoint may indicate an action to be performed, or may be used for a trigger, possibly associated with the MR or another LR. For example, a WTRU may be configured with one or more codepoint(s) which indicate an action to be performed by the WTRU, possibly associated with a specific function. For example, reception of an LP signal may indicate the WTRU to report CSI measurements, turn on/off CSI measurements, and/or turn on/off RLM/RLF.

A codepoint may indicate a function at the WTRU, for which an action is to be performed, which is to be configured, etc. For example, a WTRU may be configured with one or more codepoint(s) which indicate a function at the WTRU, such as, PDCCH search space change/enable/disable, RLF, CSI measurements, RRM measurements, WTRU-based mobility (e.g., LTM, etc.), BWP activation/deactivation, etc.

A codepoint may indicate a resource or a set of resources. For example, a WTRU may receive, in a LP signal codepoint, an indication of a specific set of resources for measuring CSI-RS and/or an indication of the frequency bandwidth associated with a carrier, a BWP, or the WTRU's operating bandwidth. The WTRU may receive, in an LP signal codepoint, an indication of a resource or set of resources (e.g., a configured grant). For example, the WTRU may receive an LP signal(s) that activates a specific configured grant resource, possibly after a period of time, or at the next time the WTRU turns on the MR.

A codepoint may indicate a decoding rule or format for a subsequent network signal, message, protocol, etc. For example, a WTRU may receive, in an LP signal codepoint, an indication of the decoding rule(s) that are applicable to subsequent network signaling or messages, possibly transmitted on the MR. For example, the WTRU may receive an LP signal that indicates one or more of: the DCI formats that can be expected to be received by the MR, possibly at the next time the WTRU turns on the MR; the search space configuration(s) to be enabled/configured on the MR, possibly at the next time the WTRU turns on the MR; the time/frequency/resource block configuration to assume on the set of resources managed by the MR, possibly at the next time the WTRU turns on the MR, including for example the slot length, frame length, numerology, inter-carrier subspacing, RB size (e.g., number of OFDM symbols in an RB), number of allocated RBs for each DCI or DCI codepoint associated with a grant, etc.; and/or the expected format of a protocol message (e.g., MAC header format, MAC CE format, included MAC CEs, RRC message format, etc.).

A codepoint may indicate a configuration element that a subsequent configuration message may refer to. For example, a WTRU may receive, in an LP signal codepoint, an indication of a bearer, QoS flow, service, slice, or similar part of the WTRU. The subsequent message (e.g., a MAC CE, or RRC message) received on the MR may then configure the indicated bearer, etc.

A codepoint may indicate a combination of multiple options disclosed herein. For example, a codepoint indicated by an (e.g., one) LP signal(s) may indicate both a function at the WTRU (e.g., RLM, CSI measurements) and a configuration being referenced (e.g., one of a number of stored configurations for that function). When the WTRU receives an LP signal(s) with such a codepoint, it may apply the indicated configuration for the indicated function. A codepoint may indicate an action to be performed and a group of WTRUs. For example, upon receiving an LP signal(s) indicating a codepoint, if the WTRU is part of the group of WTRUs indicated by the codepoint (e.g., the codepoint indicates the ID of the WTRU) and if the codepoint indicates a trigger to start CSI measurements, the WTRU may start CSI measurements.

A codepoint may indicate multiple representations by associating a number of bits of the codepoint to the specific representation (e.g., first x bits for a first representation, second x bits for a second representation, etc.). Alternatively, multiple LP signals (e.g., received in different carriers, BWPs, etc.) may be configured to indicate different representations. RRC or MAC configuration(s) may associate an (e.g., each) LP signal and a subset of its codepoints with the specific representation.

LP signal(s) may control monitoring of (an) other LP signal(s). For example, an LP signal may control the monitoring or configuration of another LP signal. For example, reception of an LP signal, possibly signaling a codepoint, may enable/disable or modify functions or codepoints of another LP signal. A first LP signal may configure the time/frequency resources monitored by the WTRU of another LP signal. A first LP signal may change the WTRU IDs associated with codepoints of a second LP signal.

CSI measurement/reporting may be performed. A WTRU may receive, using an LP signal, an indication of whether/when to turn on CSI measurements and reporting associated with the main radio. For example, upon reception of an LP signal, the WTRU may measure and report one or more (e.g., a configured number) of CSI measurements, possibly without performing PDCCH monitoring. For example, upon reception of an LP-signal, the WTRU may be configured to initiate CSI measurements and reporting a configured period of time prior to the WTRU's configured PDCCH monitoring occasion(s) (e.g., paging occasion, DRX on duration, etc.). Upon reception of an LP signal, the WTRU may be configured with a CSI reporting periodicity indicated by the LP signal (or a configuration associated with the LP signal codepoint) which the WTRU may apply the next time the WTRU turns on the main radio. For example, if the WTRU receives an LP signal with a specific codepoint, the WTRU may initiate CSI measurements prior (e.g., early) to the WTRU's PDCCH monitoring occasion. Otherwise, the WTRU may not initiate early CSI measurements, and may initiate CSI measurements (e.g., only) during the PDCCH monitoring period. Upon reception of an LP signal, the WTRU may be configured to turn on/off periodic CSI measurements to be performed outside of the active PDCCH monitoring periods. Upon reception of an LP signal, the WTRU may be configured with a minimum or maximum time after the next LP signal after which CSI measurements may be initiated. Upon reception of an LP signal, the WTRU may be configured with a minimum or maximum time after CSI measurement activation where the WTRU may receive PDCCH/DCI.

A WTRU may receive, using an LP signal, an indication of the resources or set of resources over which to perform CSI measurements. For example, the LP signal may indicate one or more of: a (pre-) configured bandwidth part or carrier (e.g., or set of contiguous frequency resources) where CSI measurements may be enabled/disabled; a resource pool (e.g., as described herein) where CSI measurements may be enabled/disabled; and/or a maximum or minimum number of BWPs, carriers, resource pools, RBs, etc. where the WTRU may enable/disable CSI measurements.

A WTRU may receive CSI measurement and/or reporting configuration in an LP signal. For example, a WTRU may receive, in an LP signal prior to turning on the main radio, an indication of the specific CSI reference signal configuration, beams to measure, TCI states, etc. (e.g., potentially received in RRC or MAC CE at a prior time).

BWP, carrier, or resource pool activation/deactivation may be described herein. A WTRU may receive, using an LP signal, an activation and/or configuration of active bandwidth, resources or set of resources. A WTRU may be configured with active behavior (e.g., PDCCH monitoring, CSI measurements, RLM/RLF, BFD, etc.) and inactive behavior (e.g., no PDCCH monitoring, limited CSI measurements, limited RLM/RLF, etc.). The (e.g., each of the) active and/or inactive behavior(s) may be configured by network signaling on the MR (e.g., RRC, MAC CE, DCI, etc.). Furthermore, the WTRU may receive an LP signal which changes the active or inactive behavior. For example, the WTRU may receive an LP signal that: changes the active/inactive behavior from one configuration to another; activates a function as part of the inactive behavior; deactivates a function as part of the active behavior; and/or turns on/off any of the following in a BWP, resource pool, or carrier: RLM/RLF for a BWP (e.g., indicate which BWP is used for RLF determination); RRM measurements; PDCCH monitoring; and/or SRS.

A WTRU may receive, using an LP signal, a configuration of resources or an indication to a configuration of resources to use for a BWP, carrier, resource pool or similar. For example, the LP signal may indicate a (pre-) configured center frequency and bandwidth of contiguous resources to be used by the WTRU. For example, the LP signal may indicate an increase or decrease in the bandwidth by a certain amount or certain set of RBs. For example, the LP signal may switch the WTRU from one configured resource pattern to another for the BWP or carrier being used by the WTRU.

A WTRU may receive, using an LP signal, a configuration of contiguous transmission resources or parts to be usable by the WTRU. For example, the LP signal may indicate the number of contiguous frequency resource transmissions (e.g., in a single slot) the WTRU should be prepared to perform. Such may be associated with a number of front-end transceivers the WTRU should enable at a given time. For example, the LP signal may indicate the number of TX/RX chains to be enabled by the WTRU (e.g., to perform simultaneous transmission or reception) on a given BWP.

Configured grant resource activation/deactivation may be performed. A WTRU may receive an LP signal which activates, deactivates or changes the configured grant resources used by the WTRU. For example, the LP signal may indicate a configured grant index associated with the configured grant resource to activate/deactivate. For example, the LP signal may indicate to the WTRU to skip specific instances of a configured grant resource (e.g., the next instance after the reception of the LP signal).

A WTRU may receive an LP signal which sets/changes the configuration of the resources associated with the configured grant, such as the number of resources, the periodicity, the offset, the MCS/encoding to use during transmission, etc. A WTRU may receive an LP signal which enables/disables a LCH restriction associated with a configured grant.

Uplink transmission/sounding resource activation may be disclosed herein. A WTRU may receive an LP signal which activates, deactivates, or changes the resources associated with transmission of uplink sounding signals such as SRS. For example, the LP signal may: activate SRS transmission for a resource set or resource pool; trigger a single or N transmissions of an SRS; change the periodicity of the SRS transmission; change the resources of the SRS transmission; change the resources in which to transmit SRS; and/or set or change the configuration of the SRS transmission (e.g., SRS transmit power, sequence, etc.).

Uplink control channel configuration may be disclosed herein. A WTRU may receive an LP signal which activates, deactivates, or changes the configuration of an uplink control channel (e.g., PUCCH). For example, the LP signal may: activate/deactivate a configured set of SR resources; change from one SR configuration to another, which may include changing SR transmission restrictions, SR prohibit timers, etc.; and/or designate a subsequent resource to act as a PUCCH or SR resource.

MRSS may be disclosed herein. A WTRU may receive an LP signal which reconfigures MRSS functionality. For example, the LP signal may: change from one configuration of resource split for MRSS to another configuration; and/or change the main RAT (e.g., from 5G to 6G) associated with the WTRU, where the main RAT may be associated with the RAT in which the WTRU performs access, UL control signal transmission, DL control signal reception, LP-WUS reception, etc.

RRM measurements and mobility may be disclosed herein. A WTRU may receive an LP signal which enables, disables, or reconfigures RRM measurements or mobility configuration. For example, an LP signal may: enable/disable RRM measurements; change the events to be monitored/reported by the WTRU; and/or change the mobility mechanism to be used at the WTRU (e.g., L3 vs L1/2).

LP signal codepoint configuration may apply for a finite time. LP signal codepoint configuration (e.g., the time/frequency location for monitoring, the significance of a received signal in terms of WTRU behavior, etc.) may be finite in time duration.

A semi-static configuration may be used. A WTRU may be configured semi-statically with a specific configuration of LP signal and corresponding codepoint significance. For example, a WTRU may receive a configuration for the LP signal on the MR (e.g., via RRC or MAC CE). When the WTRU receives such a configuration, the WTRU may maintain the configuration until it is reconfigured at another time. Specifically, when monitoring an LP signal, a WTRU may (e.g., always) use the last valid configuration of the LP signal at that time.

A timer-based configuration may be used. A WTRU may apply an LP signal configuration for a period of time. For example, the WTRU may apply the configuration for a period of time following reception of the configuration (e.g., via MAC CE or RRC), after which, the WTRU may release such configuration. Upon release of the configuration, the WTRU may operate under a default configuration of the LP signal. For example, default configuration of the LP signal may consist of a defined behavior for the WTRU associated with the set of resources monitored. For example, the WTRU may (e.g., always) turn off CSI measurements when MR is turned off and the WTRU is monitoring the LR for a carrier or a BWP. For example, the WTRU may not perform RLM/RLF, etc. Alternatively, upon release of the configuration, the WTRU may maintain the MR active until the next configuration of the LP signal is received.

Implicit maintenance of the configuration may be disclosed herein. In an example (e.g., which may be used along with the timer-based approach), the WTRU may be configured with triggers or events which allow the WTRU to maintain the current configuration. For example, if the WTRU detects an event or a trigger before the timer expires, the WTRU may maintain the configuration active and/or restart the timer associated with releasing the configuration. Specifically, a WTRU may release the configuration (e.g., only) after a period of time has elapsed since there has been no (re-)configuration of the LP signal and/or no event or trigger associated with maintenance.

Events or triggers associated with maintenance may include a scheduling event and/or an explicit request by the network.

Events or triggers associated with maintenance may include a scheduling event. For example, the event may consist of: the WTRU receiving DCI scheduling (e.g., a single grant, a number of grants, a number of grants in a configured period of time, etc.); and/or the WTRU not receiving any DCI scheduling, or receiving at most N grants. The trigger may further be conditioned on the specific resources in which the grant is sent (e.g., if received on specific time or frequency resources which are added to the default operating resources by the LP WUS configuration).

Events or triggers associated with maintenance may include an explicit request by the network. For example, the WTRU may receive a DCI, MAC CE, or similar explicit message which indicates to maintain the LP signal configuration and/or to release the LP signal configuration.

LP signal configuration may further be conditioned on other factors at the WTRU. An LP signal configuration may be further conditioned on other configuration factors at the WTRU. For example, a WTRU may determine its LP signal configuration (e.g., the monitoring occasions, the WTRU behavior associated with codepoints, etc.) based on factors associated with the expected or available data or QoS at the WTRU. For example, the LP configuration may be determined based on the bearer configuration. If the WTRU is configured with a (e.g., at least one) type of bearer (e.g., a bearer with a LCH priority above a threshold, a bearer allowing certain functionality at the WTRU, etc.), the WTRU may assume a first LP signal configuration; otherwise, it may assume a second LP signal configuration. For example, if the WTRU is configured with at least one QoS flow of a give type, the WTRU may assume a first LP signal configuration; otherwise, it may assume a second LP signal configuration.

The WTRU may dynamically change LP signal configuration based on data available for transmission and/or data reported to the network (e.g., in buffer status report (BSR)). For example, if the amount of data available for transmission at the WTRU is above/below a threshold, possibly for a specific logical channel or logical channel group, the WTRU may assume a first LP signal configuration; otherwise, it may assume a second LP signal configuration.

WTRU autonomous resource control methods may be disclosed herein. Configuration of DRX may allow a WTRU to adapt the time-based resources in which the WTRU monitors PDCCH. However, such DRX behavior may be applied to a fixed set of frequency resources defined by the WTRU's BWP and BWP switching requires the ability to receive DCI for the BWP switch itself.

Resource behavior may be a function of WTRU triggers. Resource behavior, as defined herein, may be a function of triggers defined at the WTRU.

Resource behavior may be assumed to be the resources (e.g., the number of BWPs, the number of PRBs, etc.) which are considered to be activated at the WTRU (e.g., the WTRU monitors PDCCH, the WTRU measures CSI, etc.) upon reception of an LP signal. While the activated resources may be configured and/or signaled in the LP signal, the WTRU may also use conditions described herein to determine or modify them.

Additionally and/or alternatively, resource behavior may be assumed to be the search space and/or coreset associated with WTRU monitoring. While the search space and/or coreset may be configured and/or signaled in the LP signal, the WTRU may also use conditions described herein to determine or modify them.

Without limiting the applicability to the embodiments disclosed herein, any resource behavior as defined herein may be modified based on the conditions, or mechanisms described herein in a similar fashion.

Resource behavior (e.g., possibly following LP signal reception) may be determined by measurements (e.g., CSI). The monitored resources associated with the MR (e.g., the frequency range, the BWPs, the carriers, the PRBs, etc.) may be a function of the measurements (e.g., CSI measurements) taken by the WTRU and/or reported to the network.

A WTRU may receive an LP signal which initiates CSI measurements and reporting on a first set of resources. The set of resources may be defined based on mechanisms described herein. For example, the set of resources may be configured by RRC, and indicated by the LP signal. Such reporting on the first set of resources may be performed for a first time period. For example, it may continue for a configured period of time. Alternatively, it may continue until a first CSI measurement report, N CSI measurement reports, until one or more (e.g., all) resources have had CSI measurements reported, etc. The time period may itself be indicated by the LP signal (e.g., signaled by a codepoint). Following this, the WTRU may then perform PDCCH monitoring and/or search space coreset monitoring (e.g., possibly in addition to continued CSI measurements) on second set of resources. For example, the second set of resources may be a subset of the first set of resources. The second set of resources may be determined by the WTRU based on the CSI measurements. For example, the WTRU may determine the resources to monitor based on one or more of the following rules: the WTRU may select a configured number of resources with the best/largest CSI measurements (e.g., if the WTRU is initially configured to report CSI measurements on N BWPs or carriers, it may select the X BWPs or carriers with the best CSI measurements); the WTRU may select the resources to monitor for which CSI measurements are above a configured threshold (e.g., if the WTRU is initially configured to report CSI measurements on N BWPs or carriers, it may select the BWPs or carriers for which CSI measurements are above a configured threshold); the WTRU may select a contiguous (e.g., in frequency) set of resources such that the average CSI measurements over the frequency range, possibly of a configured number of PRBs, is maximized; the WTRU may select non-contiguous frequency resources, possibly up to the capability of the WTRU or the current services or traffic/bearer configuration of the WTRU, such that the average of the CSI measurements in up to the supported contiguous bandwidth portions is maximized; and/or may include (e.g., only) the CSI measurements of the selected PBRs, resources, BWPs or bandwidth portions in the CSI measurement reports (e.g., or the WTRU may provide all CSI measurements to the network).

The WTRU may determine the PDCCH decoding mechanism (e.g., search space, coreset, DCI formats to be decoded, etc.) based on measurements. For example, if the measurements are in a first range, the WTRU may select a first coreset or search space configuration and if the measurements are in a second range the WTRU may select a second coreset or search space configuration.

The amount of time in which the resources are monitored on the MR, possibly after the reception of an LP signal, may be a function of the measurements (e.g., cell-level RSRP) taken by the WTRU and/or reported to the network in the first set of resources, or for the first period of time. For example, the WTRU may initiate measurements on a first set of resources based on reception of an LP signal. Based on those measurements performed for a first period of time, the WTRU may perform monitoring (e.g., PDCCH, etc.) or consider the set of resources to be active for a time period which is related to the determined and/or reported measurements. For example, if the measurements are within a first configured range, the WTRU may perform monitoring for a first time, while if the measurements are within a second configured range, the WTRU may perform monitoring for a second configured time. Following the configured time, the WTRU may turn off the MR and perform (e.g., only) LP signal monitoring as initially.

Resource behavior (e.g., possibly following LP signal reception) may follow a predefined/configured pattern of time and/or frequency. The WTRU may be configured to monitor PDCCH, and/or perform CSI measurements (e.g., determine the active BW) on a configured time/frequency pattern of resources. For example, the WTRU may change the number of BWPs, carriers, PRBs from a first set to a second set based on a periodic pattern. The WTRU may change from monitoring and reporting CSI measurements over a set of resources to a second set of resources based on a periodic or predefined time pattern. The first and second set of resources may correspond to the set of resources associated with determining the resource set based on CSI measurements. For example, the WTRU may perform one or more of the following: receive an LP signal which turns on the MR (e.g., the WTRU performs CSI measurements on a set of resources (e.g., PRBs), possibly indicated by the LP signal); based on CSI measurements, the WTRU may determine a second set of resources (e.g., PRBs) on which to perform PDCCH monitoring (e.g., along with CSI measurements) may be initiated after a first time period following reception of the LP signal, after a first time period following report of CSI measurements, etc.; following a second time period, the WTRU may re-initiate CSI measurements on the first set of resources (e.g., the WTRU may continue to perform PDCCH monitoring on the second set of resources during this time, and such CSI measurements may persist for a third time period); and/or following the measurements from the third time period, the WTRU may determine a new set of resources on which to monitor PDCCH (e.g., which may be different than the second set of resources, but is still a subset of the first set of resources).

The WTRU may repeat one or more of the actions described herein periodically, (e.g., a configured) number of times before turning off the MR radio, and/or until a data-based condition is met or as long as a data-based condition is met. For example, the WTRU may turn off the MR radio if the WTRU does not receive DCI scheduling UL or DL for at least a period of time and/or if does not receive DCI scheduling UL or DL for a number N of repetitions of one or more of the above.

The WTRU may receive explicit signaling (e.g., DCI, MAC CE, etc.) which turns the MR radio off.

The WTRU may perform CSI measurements on a set of resources which are not part of the actively activated resources (e.g., additional or alternate PRBs, BWPs, carriers, etc.). The WTRU may receive a configuration for the additional resources in RRC. Alternatively, the WTRU may receive an indication of the resources or an indication of such a configuration in the LP signal. For example, reception of an LP signal in a set of resources or associated with a set of resources may trigger or indicate measurement of CSI in the set of resources. Such CSI measurements may be performed periodically. For example, following reception of an LP signal, the WTRU may initiate (e.g., at least) X periods of CSI measurements in the resources associated with the LP signal.

Resource behavior may change as a result of data arrival triggers.

In an example (e.g., which may be used in combination with previous solutions), resource behavior (e.g., CSI measurement bandwidth or resources, PDCCH monitoring resources or bandwidth, etc.) may further depend on data and/or scheduling related triggers. Such triggers may consist of DL data triggers (e.g., reception of data, reception of DL scheduling), UL data triggers (e.g., arrival of UL data, transmission of SR/BSR), and/or QoS related conditions (e.g., configured bearers or QoS flows).

SRS may be dependent on SR/BSR/UL data transmission. SRS resource configuration and transmission characteristics may depend on SR/BSR transmission by the WTRU (e.g., the presence of SR/BSR transmission, the type of SR triggered, the quantity reported in BSR, etc.).

SRS transmission activation may depend on SR/BSR transmission. For example, a WTRU may activate SRS transmission upon the trigger of SR/BSR. If the WTRU transmits SR, it may initiate transmission of SRS on its operating resources. Such activation may be limited to a set or subset of resources configured at the WTRU. For example, a WTRU may operate on a first set of resources (e.g., UL BWP, UL carrier, etc) where it regularly transmits SRS. Upon trigger of SR, or upon trigger of BSR with certain conditions (e.g., the amount of resources reported by BSR is above a threshold), the WTRU may transmit SRS on a second set of resources. The WTRU may transmit SRS on a different set of resources depending on the SR triggered and/or BSR information. For example, the WTRU may be configured with one or more (e.g., two) different SRS configurations. Depending on the amount of data pending for transmission at the WTRU, the WTRU may transmit a first SR or a second SR. Alternatively, the WTRU may communicate the amount of data pending to the network in the BSR. If the amount of data pending is above a threshold, the WTRU may transmit SRS based on a first configuration (e.g., a first set of resources, a first number of BWPs, a first number of PRBs, etc.); otherwise it may transmit SRS based on a second configuration (e.g., a second set of resources, a second number of BWPs, a second number of PRBs, etc.).

The WTRU may trigger such behavior upon reception of an LP signal which turns on the MR at the WTRU. For example, the LP signal may initiate PDCCH monitoring at the WTRU on a set of resources without SRS transmission. While the monitoring occurs, if the WTRU triggers SR/BSR, the WTRU may initiate SRS transmission on the set of resources (e.g., on specific resources configured within the set of monitoring resources).

A WTRU may scale the bandwidth of SRS transmission based on the availability of new data. For example, for a (e.g., each) reported BSR, the WTRU may determine the subsequent configuration of SRS transmissions based on the amount of data reported in the BSR. Furthermore, the WTRU may stop SRS transmission, possibly on a specific set of resources, after a time period, possibly in which the WTRU reports no buffer status, or buffer status below a threshold. Such functionality may be limited to buffer status reported for certain logical channels or logical channel groups (e.g., only).

CG activation/deactivation based on SR/BSR/UL data transmission may be disclosed herein. A CG grant at the WTRU, possibly configured in an initially deactivated set of resources, may be activated based on SR/BSR triggers or conditions. For example, such triggers may further be configured per QoS flow, bearer, logical channel (LCH), etc.

If the BSR reported for a specific LCH or logical channel group (LCG) is above a threshold, the WTRU may activate a configured set of resources and/or a CG resource configured within that configured set of resources. If the BSR reported for a specific LCH or LCH is below a threshold, possibly for a number of reports, the WTRU may deactivate a CG resource within a set of resources, or may deactivate that set of resources.

1. A wireless transmit/receive unit (WTRU) comprising:
a processor configured to:
receive, from a network, an indication of a threshold value and a mapping of one or more codepoints to respective frequency resource configurations;
receive one or more low-power signals;
detect, based on the received one or more low-power signals, a codepoint of the one or more codepoints;
determine, based on the detected codepoint and the mapping, a frequency resource configuration associated with the detected codepoint;
measure, based on the determined frequency resource configuration, one or more frequency resources; and
transmit, to the network, indications of measurements associated with a subset of the one or more frequency resources.

2. The WTRU of claim 1, wherein the processor being configured to detect the codepoint of the one or more codepoints comprises the processor being configured to determine one or more transmission characteristics of the one or more low-power signals.

3. The WTRU of claim 2, wherein the one or more transmission characteristics of the one or more low-power signals comprise one or more of: a transmission time associated with the one or more low-power signals; a reception time associated with the one or more low-power signals; a transmission duration associated with the one or more low-power signals; a transmission frequency associated with the one or more low-power signals; or an encoding method associated with the one or more low-power signals.

4. The WTRU of claim 1, wherein the processor being configured to transmit, to the network, indications of measurements associated with a subset of the one or more frequency resources comprises the processor being configured to:
measure a first frequency resource;
determine that the first frequency resource is associated with a channel state information (CSI) reference signal received power (RSRP) value that is greater than the received threshold value; and
transmit, to the network, an indication of a measurement associated with the first frequency resource.

5. The WTRU of claim 4, wherein the processor being configured to transmit, to the network, indications of measurements associated with a subset of the one or more frequency resources comprises the processor being configured to:
measure a second frequency resource;
determine that the second frequency resource is associated with a CSI RSRP value that is less than or equal to the received threshold value; and
determine not to transmit an indication of a measurement associated with the second frequency resource.

6. The WTRU of claim 1, wherein each frequency resource configuration comprises one or more of: a respective configured resource configuration; a respective set of configured carriers or resource blocks (RBs); a respective configured center frequency, bandwidth, and numerology; or a respective CSI measurement configuration.

7. The WTRU of claim 6, wherein the respective CSI measurement configuration comprises one or more of: an indication of one or more reference signals; a minimum or maximum CSI reporting time; a minimum or maximum time between reception of a low-power signal of the one or more low-power signals and physical downlink control channel monitoring; an association between a low-power signal occasion and a main radio (MR) associated with the WTRU; or a WTRU monitoring procedure.

8. The WTRU of claim 1, wherein the processor is further configured to monitor for the one or more low-power signals in a configured set of monitoring occasions.

9. The WTRU of claim 1, wherein the processor is further configured to activate physical downlink control channel (PDCCH) monitoring in the one or more frequency resources within a configured PDCCH monitoring latency.

10. The WTRU of claim 1, wherein the indication of the threshold value and the mapping of the one or more codepoints to the respective frequency resource configurations are received via a radio resource control (RRC) message.

11. A method implemented in a wireless transmit/receive unit (WTRU), the method comprising:
receiving, from a network, an indication of a threshold value and a mapping of one or more codepoints to respective frequency resource configurations;
receiving one or more low-power signals;
detecting, based on the received one or more low-power signals, a codepoint of the one or more codepoints;
determining, based on the detected codepoint and the mapping, a frequency resource configuration associated with the detected codepoint;
measuring, based on the determined frequency resource configuration, one or more frequency resources; and
transmitting, to the network, indications of measurements associated with a subset of the one or more frequency resources.

12. The method of claim 11, wherein detecting the codepoint of the one or more codepoints comprises determining one or more transmission characteristics of the one or more low-power signals.

13. The method of claim 12, wherein the one or more transmission characteristics of the one or more low-power signals comprise one or more of: a transmission time associated with the one or more low-power signals; a reception time associated with the one or more low-power signals; a transmission duration associated with the one or more low-power signals; a transmission frequency associated with the one or more low-power signals; or an encoding method associated with the one or more low-power signals.

14. The method of claim 11, wherein transmitting indications of measurements associated with a subset of the one or more frequency resources comprises:
measuring a first frequency resource;
determining that the first frequency resource is associated with a channel state information (CSI) reference signal received power (RSRP) value that is greater than the received threshold value; and
transmitting, to the network, an indication of a measurement associated with the first frequency resource.

15. The method of claim 14, wherein transmitting indications of measurements associated with a subset of the one or more frequency resources comprises:
measuring a second frequency resource;
determining that the second frequency resource is associated with a CSI RSRP value that is less than or equal to the received threshold value; and
determining not to transmit an indication of a measurement associated with the second frequency resource.

16. The method of claim 11, wherein each frequency resource configuration comprises one or more of: a respective configured resource configuration; a respective set of configured carriers or resource blocks (RBs); a respective configured center frequency, bandwidth, and numerology; or a respective CSI measurement configuration.

17. The method of claim 16, wherein the respective CSI measurement configuration comprises one or more of: an indication of one or more reference signals; a minimum or maximum CSI reporting time; a minimum or maximum time between reception of a low-power signal of the one or more low-power signals and physical downlink control channel monitoring; an association between a low-power signal occasion and a main radio (MR) associated with the WTRU; or a WTRU monitoring procedure.

18. The method of claim 11, further comprising monitoring for the one or more low-power signals in a configured set of monitoring occasions.

19. The method of claim 11, further comprising activating physical downlink control channel (PDCCH) monitoring in the one or more frequency resources within a configured PDCCH monitoring latency.

20. The method of claim 11, wherein the indication of the threshold value and the mapping of the one or more codepoints to the respective frequency resource configurations are received via a radio resource control (RRC) message.
